(19) United States
(12) Patent Application Publication
(10) Pub. No.: US 2014/0007945 A1
(43) Pub. Date: Jan. 9, 2014

(54) LIQUID LEVEL DEVICE FOR EFFECTIVE CROP GROWTH

(71) Applicant: Ah Ngau FAH, Keysborough (AU)

(72) Inventor: Ah Ngau FAH, Keysborough (AU)

(21) Appl. No.: 13/775,332

(22) Filed: Feb. 25, 2013

(30) Foreign Application Priority Data
Feb. 23, 2012 (AU) 2012900688

(51) Int. Cl. A01G 25/16

(52) U.S. Cl. CPC A01G 25/16
USPC 137/2; 137/409; 137/386

(57) ABSTRACT

An improved liquid level control device for improving growing conditions and efficient crop growth in a series of plant pots includes a first valve means, a connection means, and a second valve means. The first valve means is operable to control a liquid level in a first pot. The connection means is mounted to a portion of the first valve means. The connection means includes an inlet connectable to a liquid source and an outlet for directing liquid to a remote plant pot. The second valve means is slidably received within the connection means and is operably connected to the first valve means. The second valve means is adapted to move between a first position allowing liquid communication between the inlet and outlet, and a second position substantially closing communication between the inlet and outlet depending on the liquid level within the first plant pot.

### FIELD OF THE INVENTION

This invention relates to an improved liquid level control device for improving growth conditions of plants and crops. In particular the present invention relates to an improved liquid level control device for use in crop production efficiency and producing effective growing conditions for crops.

### BACKGROUND

Generally, in order to optimise crop growth and viability by conventional irrigation methods, the volume of water required is very high. Often this is in the order of from 1 litre per plant per day (for tomatoes) to several hundreds of litres (for large palm trees) of water per plant per day. Such high rates of water consumption place a strain on water resources and may even contribute to increases in salinity levels in the soil.

One traditional method of providing water to a plant or crop is spray irrigation. Spray irrigation involves the installation of a relatively wide bore water reticulation system, the provision of spray heads, and the provision of a pumping system which is generally powered by mains electricity or by an internal combustion engine. This infrastructure is expensive, and is labor intensive to maintain.

Another system which has been used to conserve water usage has included a length of small bore tubing incorporating a plurality of fine openings along its length of less than about 0.1 mm in diameter for drip irrigation. In such a system water is fed through a reticulation system, which in turn provides a slow drip of water to a number of plants, from the fine bore tubing.

There are several problems with this type of system. Firstly the openings are required to be fine/small because if they were of a relatively large diameter, the water pressure would decrease with progressive distance from a water source. In this situation plants located at a distance from a liquid source are likely to receive increasingly less water. Secondly, because the holes are minute, they can very easily be blocked by dirt particles or even crystallised nutrient and even the tubing itself can become blocked by nutrients that crystallize out after shut-down of the feed system, to substantially decrease or even prevent flow therethrough. And thirdly, to prevent blockage, systems of this type incorporate complex and expensive filtration systems to filter dirt and the like from entering the hose line.

With conscious efforts to conserve water and as a result of the effects on water supply by conventional irrigation methods, some attempts have been made to develop alternative systems to both conserve water and meet the requirements for plant and/or crop growth. One such attempt is described in Australian Patent No. 2004200168, which is directed to a mechanical liquid level control device.

While the device described in Australian Patent No. 2004200168 represents an effective means for controlling the level of liquid in a plant pot, it is found that when large numbers of plant pots are connected in a series for production of commercial quantities of a crop, crop growth in plant pots progressively decreases with increasing distance from a liquid source.

The observed decline in crop growth in a series of plant pots is associated with a process of nutrient poaching. When a large number of plant pots are connected in series for commercial production of a crop using the device in Patent No. 2004200168, it s fond that crop plants in pots closest to the liquid source consume a higher proportion of nutrition available from the liquid source, leaving plant pots further from the liquid source with less available nutrition and with lower crop yield. This phenomenon is reflected in poorer crop growth and crop yield in plant pots as distance from the liquid source increases.

It would be an advantage to provide an improved means of optimising plant/crop growing conditions for effective crop growth in commercial quantities which optimises crop growth conditions while minimising water consumption.

It is therefore an object of the present invention to ameliorate one or more of the disadvantages of the prior art. A further object of the present invention is to provide the public with a useful alternative.

### SUMMARY OF THE INVENTION

In the present invention there is disclosed an improved liquid level control device for improving growing conditions and efficient crop growth in a series of plant pots including:

a first valve means for controlling the liquid level in a first plant pot;
a connection means mounted to a portion of the first valve means, the connection means including an inlet connectable to a liquid source and an outlet for directing liquid to a remote plant pot, and
a second valve means slidably received within the connection means and operably connected to the first valve means, wherein the second valve means is adapted to move between a first position allowing liquid communication between the inlet and outlet, and a second position substantially closing communication between the inlet and outlet depending on the liquid level within the first plant pot; and
wherein when the liquid level within the first plant pot reaches a predetermined minimum level, liquid from the inlet urges movement of the second valve to the first position within the connection means to allow outflow of liquid, and
wherein when the liquid level within the first plant pot reaches a predetermined maximum level, the first valve urges the second valve towards the second position within the connection means to close the outlet; and
wherein opening and closing the outlet of the connection means being cyclical depending on the level of liquid in the first pot.

The present invention represents an improvement over the prior art by being able to redirect inflow of liquid from a liquid source to a remote location through the outflow pathway. The redirection of liquid inflows allows redistribution of liquid from the source thereby controlling nutrient uptake by plant pots remote from the liquid source in a series of plant pots.

The first valve means can include a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot reaches a predetermined minimum, and wherein the first float is urged towards the opening when liquid in the plant pot reaches a predetermined upper level.

The connection means can include:

a liquid inflow pathway interconnectable to a liquid source;

a liquid outflow pathway downstream from and in liquid communication with the liquid inflow pathway, the liquid outflow pathway being substantially perpendicular to the liquid inflow pathway for directing liquid away from the plant pot in a first operating condition; and

a throat portion extending from the casing opening to the liquid inflow pathway, wherein the throat portion includes an internal housing of greater diameter than the liquid inflow pathway.

In a related aspect of the present invention there is disclosed an improved liquid level control device for redirecting liquid inflow improving growing conditions and efficient crop growth including:

a first valve means for locating in a plant pot or the like including a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot reaches a predetermined minimum, and wherein the first float is urged towards the opening when liquid in the plant pot reaches a predetermined upper level;

a connection means mounted to the casing over the opening, the connection means including:

a liquid inflow pathway interconnectable to a liquid source:

a liquid outflow pathway downstream from and in liquid communication with the liquid inflow pathway, the liquid outflow pathway being substantially perpendicular to the liquid inflow pathway for directing liquid away from the plant pot in a first operating condition; and

a throat portion extending from the casing opening to the liquid inflow pathway, wherein the throat portion includes an internal housing of greater diameter than the liquid inflow pathway;

a second valve means slidably received within the internal housing and being movable between the casing opening and liquid inflow pathway;

wherein in the first operating condition when the liquid level in the plant pot reaches a predetermined minimum, liquid pressure from the liquid source urges movement of the second valve means towards the casing opening so that liquid can flow from the inflow pathway to the outflow pathway under pressure for redirecting liquid away from the plant pot to a remote location; and

wherein in a second operating condition when liquid in the plant pot reaches the predetermined upper level, the first float urges against the second valve means moving the second valve means towards the first liquid pathway substantially restricting liquid flow from the liquid inflow to the liquid outflow pathway; and

wherein replenishment of liquid being cyclical depending on the liquid level in the plant pot.

The liquid inflow pathway can include a first connecting head interconnectable to a liquid source, wherein the first connecting head defines a first internal liquid pathway substantially in alignment with the opening of the casing.

The liquid outflow pathway can include a second connecting head defining a second internal liquid pathway substantially perpendicular to and in liquid communication with the first liquid pathway, wherein the second connecting head is adapted to redirect liquid from the liquid source through the second internal pathway to a remote location downstream therefrom in a first operating condition.

The throat portion can include an internal throat passage in alignment with the liquid inflow pathway, the internal throat passage being of greater internal diameter than the first internal liquid pathway.

In a related aspect of the present invention there is disclosed an improved liquid level control device for redirecting liquid inflow improving growing conditions and efficient crop growth including:

a first valve means for locating in a plant pot or the like including a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot is low, and wherein the first float is urged towards the opening when liquid in the plant pot reaches a predetermined upper level;

a connection means mounted on the casing over the opening, the connection means including:

a first connecting head interconnectable to a liquid source, the first connecting head defining a first internal liquid pathway substantially in alignment with the opening of the casing, a second connecting head defining a second internal liquid pathway substantially perpendicular to and in liquid communication with the first liquid pathway, wherein the second connecting head is adapted to redirect liquid from the liquid source through the second internal pathway to a remote location downstream therefrom in a first operating condition, and a throat structure intermediate the casing opening and the second internal pathway, the throat defining an internal throat passage in alignment with the first internal liquid pathway, the internal throat passage being of greater internal diameter than the first internal liquid pathway, a second valve means slidably mounted within the internal throat passage, and

wherein the second valve means is moveable towards the casing opening under liquid pressure from the source in a first operating condition when the liquid level in the plant pot is low to open passage of liquid from the source through the first and second liquid pathways thereby redirecting water outflow to a remote location, and wherein in a second operating condition when liquid within the plant pot reaches a predetermined upper level the second valve means is urged away from the casing opening by the first float towards the first internal liquid pathway whereby the second internal liquid pathway is closed.

In a further related aspect there is provided an improved liquid level control device including:

a first valve means for locating in a first plant pot;

a connection means mounted to the first valve means, wherein the connection means includes:

a connection body;

a first connecting head mounted to the connection body defining a liquid inflow passage connectable to a liquid source;

a second connecting head mounted to the connection body being connectable to a remote plant pot, the second connecting head defining a liquid outflow passage, the outflow passage being substantially perpendicular to the inflow passage and in liquid communication in a liquid outflow condition;

an internal housing immediately adjacent the first valve means and substantially aligned with the inflow passage, wherein the housing extends beyond the outflow passage ending adjacent the inflow passage; and

a second valve means slidably displaceable within the internal housing, wherein the first valve means and second valve means cooperate to allow movement of the second valve means between the first valve means, allowing liquid outflow, and the inflow passage, stopping outflow.

In yet a further related aspect, the present invention is directed to a method of controlling distribution of liquid containing nutrient from a liquid source to a series of plant pots, the method including:

providing an improved liquid level control device including:

a first valve means for locating in a first plant pot;

a connection means mounted to the first valve means, wherein the connection means includes:

a connection body,

a first connecting head mounted to the connection body defining a liquid inflow passage connectable to a liquid source;

a second connecting head mounted to the connection body being connectable to a remote plant pot, the second connecting head defining a liquid outflow passage, the outflow passage being substantially perpendicular to the inflow passage and in liquid communication in a liquid outflow condition;

an internal housing immediately adjacent the first valve means and substantially aligned with the inflow passage, wherein the housing extends beyond the outflow passage ending adjacent the inflow passage; and

a second valve means slidably displaceable within the internal housing, wherein the first valve means and second valve means cooperate to allow movement of the second valve means between the first valve means, allowing liquid outflow, and the inflow passage, stopping outflow;

placing the device into a first plant pot in a series of plant pots;

connecting the first connecting head to a liquid source;

connecting the second connecting head to a remote plant pot in the series;

pumping liquid from the source to the first connecting head;

wherein when the liquid level is at a predetermined minimum in the first plant pot, the first valve means is open allowing liquid from the liquid source to displace the second valve means to a position adjacent the first valve whereby liquid exits the second connecting head through the outflow passage and is directed to a remote plant pot, and wherein when a predetermined maximum liquid level is reached in the first plant pot, the first valve means is closed whereby upon closing, the first valve displaces the second valve means to a position adjacent the inflow passage whereby the outflow passage is blocked so that liquid is not transferred between the inflow and outflow passages until the liquid level in the first plant pot reaches the predetermined minimum liquid level.

Further exemplifications of the present invention will be described as follows with reference to the accompanying drawings. A brief description of the drawings follows:

### BRIEF DESCRIPTION OF THE DRAWINGS

FIG. 1 is a schematic representation of an improved liquid level device side elevation in accordance with the present invention.

FIG. 2A is a schematic representation of the device in FIG. 1 shown in vertical cross-section in a first mode of operation in accordance with the present invention.

FIG. 2B is an enlarged view of a section of FIG. 2A circled and marked 13′.

FIG. 3A is a schematic representation of the device in FIG. 1 shown in vertical cross-section in a second mode of operation in accordance with the present invention.

FIG. 3B is an enlarged view of a section of FIG. 3A circled and marked 13′.

FIG. 4 is a schematic representation of a prior art liquid level control device.

FIG. 5A is a schematic representation of a further embodiment of the present invention shown in vertical cross-section in a first mode of operation in accordance with the present invention.

FIG. 5B is an enlarged view of a section of FIG. 5A circled and marked 13′.

FIG. 6A is a schematic representation of the device in FIG. 5 shown in vertical cross-section in a second mode of operation in accordance with the present invention.

FIG. 6B is an enlarged view of a section of FIG. 5A circled and marked 13′.

### DETAILED DESCRIPTION OF THE PREFERRED EMBODIMENTS WITH REFERENCE TO THE ACCOMPANYING DRAWINGS

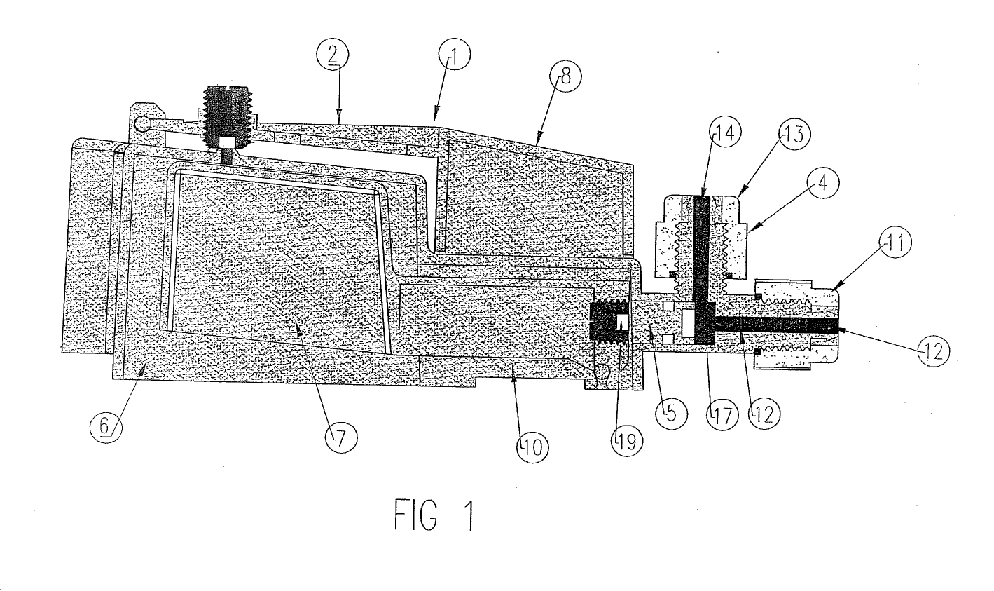

Referring to FIGS. 1 to 3B there is shown an improved liquid level control device 1 adapted to be housed within a plant pot (not shown) for controlling distribution of liquid containing nutrient, from a liquid source (not shown) to a series of plant pots (not shown).

The device 1 includes a first valve 2 and a connecting structure 4 mounted to a portion of the first valve. The device further includes a second valve 5 slidably received within a housing portion of the connecting structure 4.

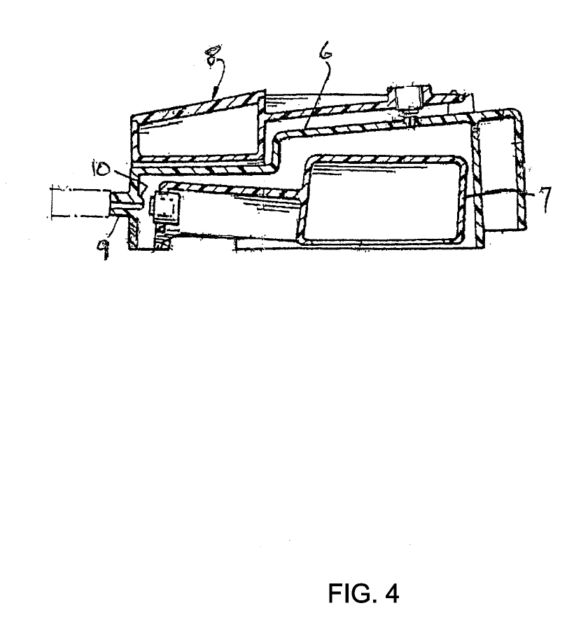

The first valve 2 (best shown in FIG. 4) includes a hollow casing 6 sandwiched between a first float 7 moveable within the casing and second float 8 moveable externally of the casing. The casing 6 has an opening 9 and a recess portion 10 for allowing liquid entering the plant pot (not shown) into the hollow casing.

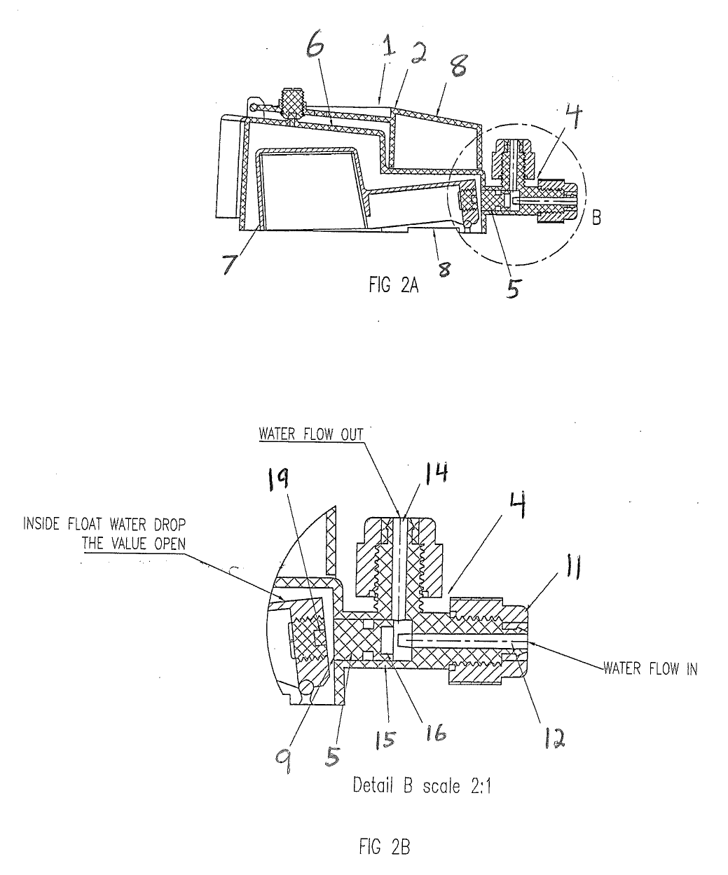

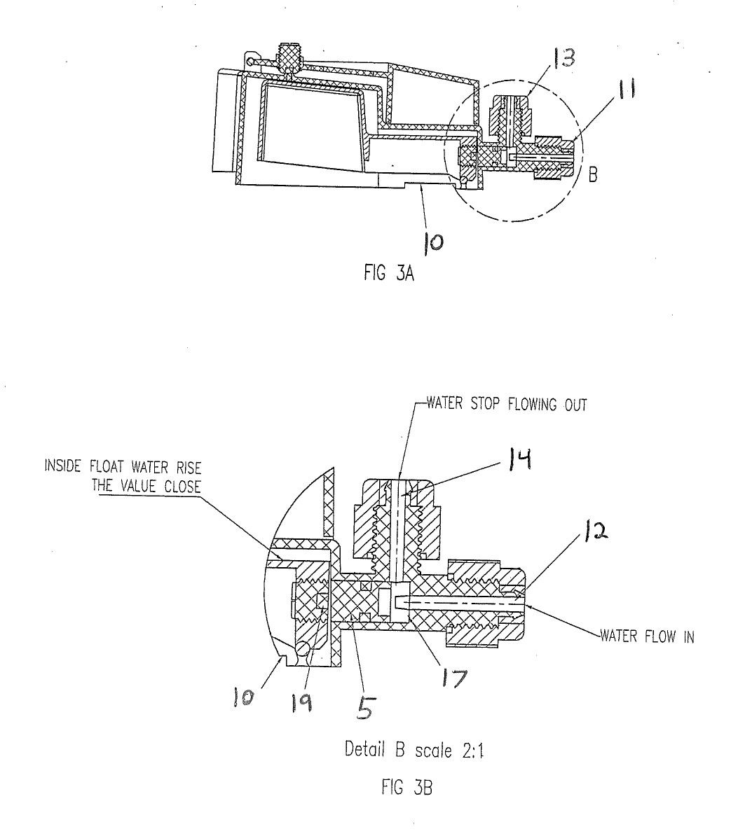

As shown in FIG. 2A and 2B, the first and second floats 7 & 8 cooperate with the casing 6 so that the first float 7 moves away from the opening 9 when liquid within the plant pot reaches a predetermined minimum level. Conversely, as shown in FIGS. 3A and 3B, the first float 7 is urged towards the opening 9 when liquid in the plant pot reaches a predetermined upper level. Australian Patent No. 2004200168 is incorporated herein by reference.

Referring to FIGS. 2A, 2B, 3A and 3B, the device 1 shows a connecting structure 4 mounted to the casing 6 of the first valve 2 over the opening 9. The connecting structure includes a first connecting head 11 interconnectable to a liquid source (not shown). The first connecting head 11 defines a first internal liquid pathway 12 substantially in alignment with the opening 9 of the casing 6.

The connecting structure further includes a second connecting head 13 defining a second internal liquid pathway 14 substantially perpendicular to and in liquid communication with the first liquid pathway 12. In a first operating condition the second connecting head 13 is adapted to receive and redirect liquid from the liquid source through the second internal pathway to a remote plant pot (not shown) downstream therefrom.

The connecting structure also includes a throat structure 15 intermediate the opening 9 and the second internal pathway 14. The throat 15 defines an internal throat passage 16 in alignment with the first internal liquid pathway 12 and opening 9, the internal throat passage being of greater internal diameter than the first internal liquid pathway so that internal shoulders 17 are formed at the intersection of the throat passage and first internal liquid pathway, which act as a stop surface.

The device 1 further includes a second valve 5 slidably displaceable within the internal throat passage 16. In use the first valve 2 and connecting structure cooperate to allow sliding movement of the second valve 5 between the opening 9 of the first valve, when liquid in the plant pot is low, and a position over the second internal liquid pathway 14 to substantially prevent flow of liquid from the source between the first and second internal liquid pathways.

FIGS. 2A and 2B demonstrate dynamics between the first valve and connecting structure when liquid in the plant pot (not shown) reaches a predetermined minimum level. In this embodiment, the first float 7, which includes a closure member 19, is angled downwardly thereby moving the closure member 19 away from the opening 9 of the casing 6. When this occurs, liquid from the liquid source, which is pumped from the source enters the first internal liquid pathway and urges the second valve 5 towards the opening 9 thus opening access for liquid passage between the first and second internal liquid pathways under pressure. Liquid exits the connecting head 11 and is directed to a remote plant pot (not shown) by means of a conduit (not shown).

FIGS. 3A and 3B demonstrate dynamics between the first valve and connecting structure when liquid in the plant pot (not shown) reaches a predetermined maximum level. In this embodiment, the first float 7 is shown in a relatively higher position, due to an increased liquid level whereby the closure member 19 urges against an end portion of the second valve 5. When this occurs, the second valve 5 is slidably displaced within the throat passage closing the second internal liquid pathway. The second valve is stopped from further movement into the first internal liquid passage by abutting against shoulders 17.

Until the liquid level in the plant pot (not shown) decreases to the predetermined lower level, no further transfer of liquid occurs. The combination of the first valve and the connecting structure operate cyclically to direct liquid from a liquid source to a remote plant pot and conserve liquid usage thereby addressing deficiencies with plant nutrition remote from a liquid source as well as managing liquid consumption.

Referring to figures SA, 5B, 6A and 6B there is shown an improved liquid level control device 1 adapted to be housed within a plant pot (not shown) for directing distribution of liquid from a liquid source (not shown) to a series of plant pots (not shown).

The device 1 includes a first valve 2 and a connecting structure 4 mounted thereto adjacent an opening 9 in the first valve 2. The connecting structure includes a body portion 101 having a first connecting head 11 in substantial alignment with the body, and a second connecting head 13 extending substantially perpendicular to the first connecting head 11. The first 11 and second 13 connecting heads define an internal liquid flow pathway (shown by arrows 102) between an inlet 103 in connecting head 11 and an outlet 114 in the second connecting head 13. In an assembled condition (not shown) the inlet 103 is interconnected to a liquid source by a conduit (not shown), and outlet 114 in the second connecting head 13 is interconnected to a remote plant pot in a series by a liquid conduit (not shown).

The connecting structure further includes a throat structure 15 intermediate the first valve 2 and the second connecting head 13. The throat 15 defines an internal housing 116 in substantial alignment with the first connecting head, the internal housing 116 being sized to receive therein in slidable relation a second valve 55 moveable between opening 9 in the first valve 2 and internal shoulders 17 of the connecting structure 4. The internal housing 116 has an internal diameter greater than the internal liquid pathway ending in internal shoulders 17 upstream of the second connecting head 13, which acts as a stop surface for the second valve 55.

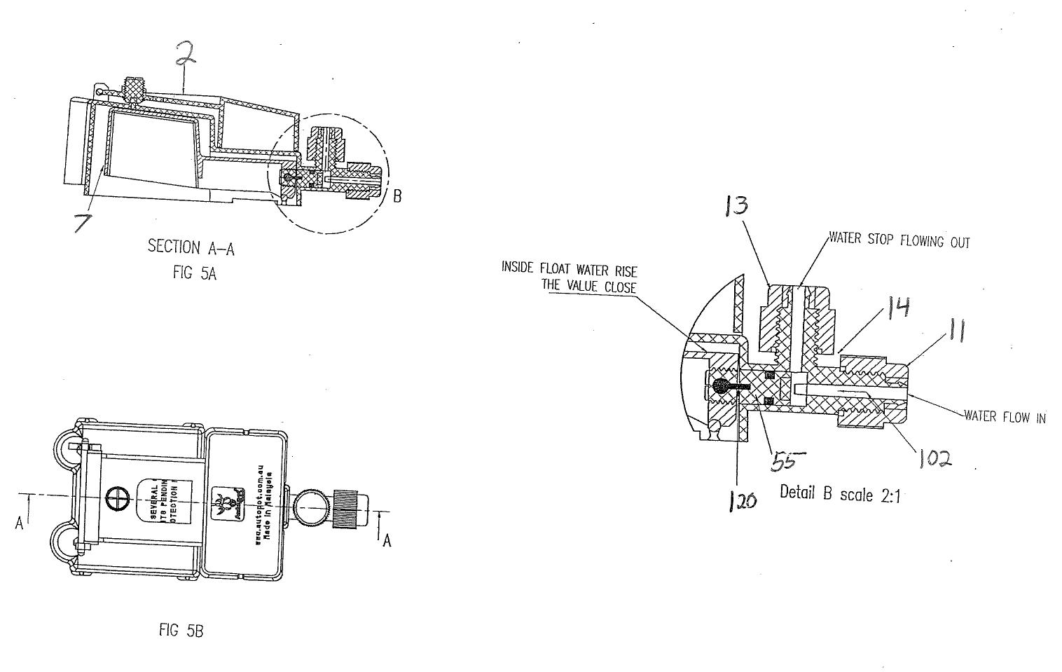

As shown, the second valve 55 is interconnected to internal float 7 of the first valve 2 by a connecting rod 120. The connecting rod 120 acts against the second valve 55 in a condition when liquid level in a plant pot (no shown) is sufficiently high. As liquid levels in the plant pot (not shown) increase causing upward movement of the internal float 7, such movement of internal float 7 causes the connecting rod to urge against the second valve 55 to drive movement of the second valve 55 towards the shoulders 17 and closing the internal pathway (see FIG. 5A).

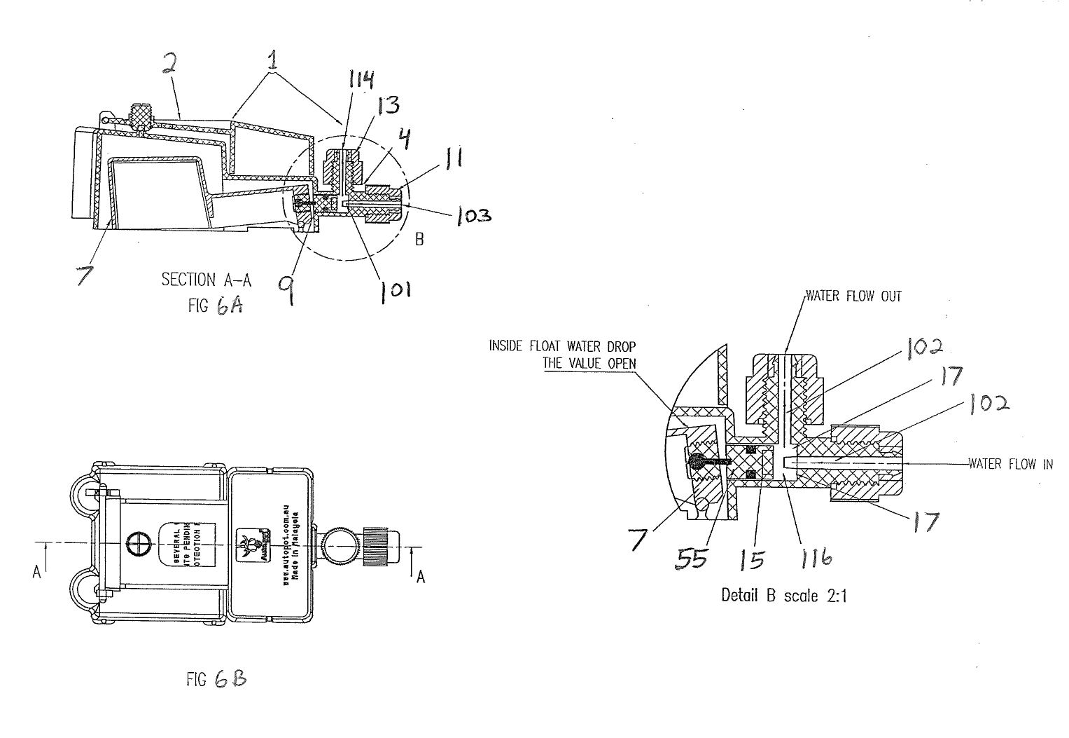

In use when the liquid level in the plant pot (not shown) reaches a predetermined minimum level, the first valve 2 and connecting structure 4 cooperate such that internal float 7 falls with decreasing liquid level releasing pressure applied by the connecting rod 120 against the second valve 55 to allow sliding movement of the second valve 55 under liquid pressure from inlet of the first connecting head 11, away from shoulders 17 and towards and partially through the opening 9 of the first valve 2. In this condition (see FIG. 6A), the internal pathway between the first and second connecting head is opened, and liquid from the source is redirected out the outlet of the second connecting head to a remote plant pot (not shown) downstream therefrom.

Until the liquid level in the plant pot (not shown) decreases to a predetermined minimum level, no further transfer of liquid occurs. The combination of the first valve and the connecting structure operate cyclically to direct liquid from a liquid source to a remote plant pot and conserve liquid usage thereby addressing deficiencies with plant nutrition remote from a liquid source as well as managing liquid consumption.

1. An improved liquid level control device for improving growing conditions and efficient crop growth in a series of plant pots including:
a first valve means for controlling the liquid level in a first plant pot;
a connection means mounted to a portion of the first valve means, the connection means including an inlet connectable to a liquid source and an outlet for directing liquid to a remote plant pot; and
a second valve means slidably received within the connection means and operably connected to the first valve means, wherein the second valve means is adapted to move between a first position allowing liquid communication between the inlet and outlet, and a second position substantially closing communication between the inlet and outlet depending on the liquid level within the first plant pot; and
wherein when the liquid level within the first plant pot reaches a predetermined minimum level, liquid from the inlet urges movement of the second valve to the first position within the connection means to allow outflow of liquid, and
wherein when the liquid level within the first plant pot reaches a predetermined maximum level, the first valve urges the second valve towards the second position within the connection means to close the outlet; and
wherein opening and closing the outlet of the connection means being cyclical depending on the level of liquid in the first pot.

2. An improved liquid level control device according to claim 1 wherein the first valve means includes a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot reaches a predetermined minimum, and wherein the first float is urged towards the opening when liquid in the plant pot reaches a predetermined upper level.

3. An improved liquid level control device according to claim 2 wherein the connection means includes:
a liquid inflow pathway interconnectable to a liquid source;
a liquid outflow pathway downstream from and in liquid communication with the liquid inflow pathway, the liquid outflow pathway being substantially perpendicular to the liquid inflow pathway for directing liquid away from the plant pot in a first operating condition; and
a throat portion extending from the casing opening to the liquid inflow pathway, wherein the throat portion includes an internal housing of greater diameter than the liquid inflow pathway.

4. An improved liquid level control device for redirecting liquid inflow improving growing conditions and efficient crop growth including:
a first valve means for locating in a plant pot or the like including a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot reaches a predetermined minimum, and wherein the first float is urged towards the opening when liquid in the plant pot reaches a predetermined upper level;
a connection means mounted to the casing over the opening, the connection means including:
a liquid inflow pathway interconnectable to a liquid source:
a liquid outflow pathway downstream from and in liquid communication with the liquid inflow pathway, the liquid outflow pathway being substantially perpendicular to the liquid inflow pathway for directing liquid away from the plant pot in a first operating condition; and
a throat portion extending from the casing opening to the liquid inflow pathway, wherein the throat portion includes an internal housing of greater diameter than the liquid inflow pathway;
a second valve means slidably received within the internal housing and being movable between the casing opening and liquid inflow pathway;
wherein in the first operating condition when the liquid level in the plant pot reaches a predetermined minimum, liquid pressure from the liquid source urges movement of the second valve means towards the casing opening so that liquid can flow from the inflow pathway to the outflow pathway under pressure for redirecting liquid away from the plant pot to a remote location; and
wherein in a second operating condition when liquid in the plant pot reaches the predetermined upper level, the first float urges against the second valve means moving the second valve means towards the first liquid pathway substantially restricting liquid flow from the liquid inflow to the liquid outflow pathway; and
wherein replenishment of liquid being cyclical depending on the liquid level in the plant pot.

5. An improved liquid level control device according to claim 4 wherein the liquid inflow pathway includes a first connecting head interconnectable to a liquid source, wherein the first connecting head defines a first internal liquid pathway substantially in alignment with the opening of the casing.

6. An improved liquid level control device according to claim 4 wherein the liquid outflow pathway includes a second connecting head defining a second internal liquid pathway substantially perpendicular to and in liquid communication with the first liquid pathway, wherein the second connecting head is adapted to redirect liquid from the liquid source through the second internal pathway to a remote location downstream therefrom in a first operating condition.

7. An improved liquid level control device according to claim 4 wherein the throat portion includes an internal throat passage in alignment with the liquid inflow pathway, the internal throat passage being of greater internal diameter than the first internal liquid pathway.

8. An improved liquid level control device for redirecting liquid inflow improving growing conditions and efficient crop growth including:
a first valve means for locating in a plant pot or the like including a hollow casing sandwiched between a first float means moveable within the housing and second float means moveable externally of the casing, the casing having an opening, and a recess potion for allowing liquid entering the plant pot into the hollow casing, wherein the first and second float means cooperate with the casing so that the first float moves away from the opening when liquid level within the plant pot is low, and wherein the first float is urged towards the opening when liquid in the plant pot reaches a predetermined upper level;
a connection means mounted on the casing over the opening, the connection means including:
a first connecting head interconnectable to a liquid source, the first connecting head defining a first internal liquid pathway substantially in alignment with the opening of the casing,
a second connecting head defining a second internal liquid pathway substantially perpendicular to and in liquid communication with the first liquid pathway, wherein the second connecting head is adapted to redirect liquid from the liquid source through the second internal pathway to a remote location downstream therefrom in a first operating condition, and
a throat structure intermediate the casing opening and the second internal pathway, the throat defining an internal throat passage in alignment with the first internal liquid pathway, the internal throat passage being of greater internal diameter than the first internal liquid pathway,
a second valve means slidably mounted within the internal throat passage, and
wherein the second valve means is moveable towards the casing opening under liquid pressure from the source in a first operating condition when the liquid level in the plant pot is low to open passage of liquid from the source through the first and second liquid pathways thereby redirecting water outflow to a remote location, and wherein in a second operating condition when liquid within the plant pot reaches a predetermined upper level the second valve means is urged away from the casing opening by the first float towards the first internal liquid pathway whereby the second internal liquid pathway is closed.

9. An improved liquid level control device including:
a first valve means for locating in a first plant pot;
a connection means mounted to the first valve means, wherein the connection means includes:
a connection body;
a first connecting head mounted to the connection body defining a liquid inflow passage connectable to a liquid source;
a second connecting head mounted to the connection body being connectable to a remote plant pot, the second connecting head defining a liquid outflow passage, the outflow passage being substantially perpendicular to the inflow passage and in liquid communication in a liquid outflow condition;
an internal housing immediately adjacent the first valve means and substantially aligned with the inflow passage, wherein the housing extends beyond the outflow passage ending adjacent the inflow passage; and
a second valve means slidably displaceable within the internal housing, wherein
the first valve means and second valve means cooperate to allow movement of the
second valve means between the first valve means, allowing liquid outflow, and the
inflow passage, stopping outflow.

10. A method of controlling distribution of liquid containing nutrient from a liquid source to a series of plant pots, the method including:
providing an improved liquid level control device including:
a first valve means for locating in a first plant pot;
a connection means mounted to the first valve means, wherein the connection means includes:
a connection body
a first connecting head mounted to the connection body defining a liquid inflow passage connectable to a liquid source;
a second connecting head mounted to the connection body being connectable to a remote plant pot, the second connecting head defining a liquid outflow passage, the outflow passage being substantially perpendicular to the inflow passage and in liquid communication in a liquid outflow condition;
an internal housing immediately adjacent the first valve means and substantially aligned with the inflow passage, wherein the housing extends beyond the outflow passage ending adjacent the inflow passage; and
a second valve means slidably displaceable within the internal housing, wherein the first valve means and second valve means cooperate to allow movement of the second valve means between the first valve means, allowing liquid outflow, and the inflow passage, stopping outflow;
placing the device into a first plant pot in a series of plant pots;
connecting the first connecting head to a liquid source;
connecting the second connecting head to a remote plant pot in the series;
pumping liquid from the source to the first connecting head;
wherein when the liquid level is at a predetermined minimum in the first plant pot, the first valve means is open allowing liquid from the liquid source to displace the second valve means to a position adjacent the first valve whereby liquid exits the second connecting head through the outflow passage and is directed to a remote plant pot, and wherein when a predetermined maximum liquid level is reached in the first plant pot, the first valve means is closed whereby upon closing, the first valve displaces the second valve means to a position adjacent the inflow passage whereby the outflow passage is blocked so that liquid is not transferred between the inflow and outflow passages until the liquid level in the first plant pot reaches the predetermined minimum liquid level.
